(19) United States
(12) Patent Application Publication
(10) Pub. No.: US 2022/0405592 A1
(43) Pub. Date: Dec. 22, 2022

(54) Multi-feature log anomaly detection method and system based on log full semantics

(71) Applicant: University of Electronic Science and Technology of China, Chengdu (CN)

(72) Inventors: Weina Niu, Chengdu (CN); Xiaosong Zhang, Chengdu (CN); Zimu Li, Chengdu (CN)

(21) Appl. No.: 17/895,076

(22) Filed: Aug. 25, 2022

(30) Foreign Application Priority Data
Mar. 10, 2022 (CN) 202210230854.3

(51) Int. Cl. G06N 3/08; G06F 40/30

(52) U.S. Cl. CPC G06N 3/08; G06F 40/30

(57) ABSTRACT

A multi-feature log anomaly detection method includes steps of: preliminarily processing a log data set to obtain a log entry word group corresponding to all semantics of a log sequence in the log data set, and using the log entry word group as a semantic feature of the log sequence; extracting a type feature, a time feature and a quantity feature of the log sequence, and encoding the semantic feature, the type feature, the time feature and the quantity feature into a log feature vector set of the log sequence; training a BiGRU neural network model with all log feature vector sets to obtain a trained BiGRU neural network mode; and inputting the log data set to be detected into the trained BiGRU neural network model for prediction, and determining whether the log sequence is a normal or abnormal log sequence according to a prediction result.

### CROSS REFERENCE OF RELATED APPLICATION

The present invention claims priority under 35 U.S.C. 119(a-d) to CN 202210230854.3, filed Mar. 10, 2022.

### BACKGROUND OF THE PRESENT INVENTION

### Field of Invention

The present invention relates to a multi-feature log anomaly detection method and system based on log full semantics for log anomaly detection, which belongs to a computer technology, and more particularly to a log anomaly detection technology in a computer operating system or a software system.

### Description of Related Arts

Generally speaking, most programs will use the “print” function somewhere when they are written to print unstructured prompts or alarm information with a certain format, so that developers or users can understand the running status and locate errors. Such information is called log. For some large-scale systems, the larger the program scale is, the larger and even more complex the number and types of logs will be.

Due to the explosive growth of logs and the high requirements for reviewers, it is almost impossible to manually review the logs. The earliest automated anomaly detection method adopts keyword regular matching, which can only detect obvious single anomalies in many cases and is very limited. It is only effective when there are clear signs in the logs, and cannot detect anomalies that cannot be located by keywords. Some subsequent clustering-based analysis schemes are an improvement for unsupervised log detection, but cannot handle many situations such as log template update and diverse anomalies. With the development of artificial intelligence, many automatic and semi-automatic optimized log anomaly detection methods based on different neural networks have gradually emerged. Some are optimized in log parsing, which extract the semantic information of logs by natural language processing methods for detection; some are optimized in models, which improve the traditional detection models for better detection results; and some apply more processing on features, which, for example, detect anomalies that are not covered by traditional features by mining other features.

So far, data mining and machine learning methods such as decision tree (DT), support vector machine (SVM) and principal component analysis (PCA) have been used to extract more relevant features. These methods improve the accuracy while reducing the complexity of the algorithm. However, it is difficult to use these methods to analyze the hidden relationships in the extracted features. A more sophisticated method, such as a deep learning method, can overcome this limitation.

In the past few years, log anomaly detection based on deep learning methods and natural language processing techniques has achieved higher accuracy by using semantic relationships in logs. Lstm and bidirectional Lstm are widely used in log anomaly detection and have achieved higher accuracy in logarithmic anomaly detection. The deep learning model based on convolutional neural network (CNN) can achieve an accuracy of 99%. Researchers have used autoencoders for feature extraction and further used DL models for anomaly detection, wherein attention mechanisms and deep learning models are used to give more consideration to specific data sequences.

Conventionally, popular processes for log anomaly detection are mainly log parsing, feature extraction and anomaly detection.

Most of the logs are unstructured data texts, which contain a large number of noise words that have nothing to do with the semantic information of the logs. Therefore, researchers generally extract log templates to remove the noise words in the logs, thereby distinguishing the log template and parameters of the system printed logs, and then extracting the semantic information by analyzing the log template. For example, in a heuristic search tree: Drain and Spell use the tree structure to parse the logs into multiple templates.

In order to increase the accuracy of log anomaly detection, researchers further uses the Word2Vec methods, such as LogAnomaly uses Template2Vec to further extract semantic information in log templates. A probability model can also be used, such as in PLELog, both abnormal and normal probability values are first assigned to each log entry, so that the unsupervised learning is improved and becomes semi-supervised or time-supervised learning, which raising the accuracy of log detection.

Most of the conventional methods are based on log templates for log anomaly detection, which have the following technical problems:

1. Due to the continuous updating of the software system, out-of-vocabulary words (OOV words) will continue to appear in the log system, and the log template will continue to change over time. When the log template is incorrectly extracted, the accuracy of log anomaly detection will also be affected.

2. The conventional methods are limited by the efficiency of the log template extraction method. For different log templates, the training performance of the conventional methods is highly varied. Furthermore, the extracted log templates cannot be applied to all types of system logs, which are generally only for one or two specific log types.

3. A single log semantic feature or a small number of features in the log template cannot cover all the information of the log entries, resulting in low accuracy of log anomaly detection.

### SUMMARY OF THE PRESENT INVENTION

An object of the present invention is to provide

In view of the above problems, an object of the present invention is to provide a multi-feature log anomaly detection method and system based on full log semantics, so as to improve the low log anomaly detection accuracy in the prior art.

Accordingly, in order to accomplish the above objects, the present invention provides

a multi-feature log anomaly detection method based on log full semantics, comprising steps of:

1: preliminarily processing a log data set to obtain a log entry word group corresponding to all semantics of a log sequence in the log data set, and using the log entry word group as a semantic feature of the log sequence, wherein the log data set comprises more than one log sequence, and the log sequence is formed by logs generated at intervals or by different processes; the log sequence comprises multiple log entries;

2: extracting a type feature, a time feature and a quantity feature of the log sequence, and encoding the semantic feature, the type feature, the time feature and the quantity feature into a log feature vector set of the log sequence, wherein the log feature vector set comprises a type feature vector, a time feature vector, a quantity feature vector and a semantic feature vector;

3: training an attention-mechanism-based BiGRU neural network model with all log feature vector sets to obtain a trained BiGRU neural network mode; and

4: inputting the log data set to be detected into the trained BiGRU neural network model for prediction, and determining whether the log sequence is a normal or abnormal log sequence according to a prediction result.

Preferably, the step 1 comprises specific steps of:

1.1: marking the log entries in the log sequence with word segmentation of natural language, in such a manner that each of the log entries obtains a marked word set, wherein words are marked as nouns or verbs;

1.2: splitting the marked word set with a delimiter, wherein the delimiter comprises spaces, colons and commas; and

1.3: converting uppercase letters in a split word set into lowercase letters, and deleting all non-character marks to obtain the log entry word group corresponding to all the semantics of the log sequence, which means the semantic feature of the log sequence is obtained, wherein the non-character marks comprise operators, punctuation, and numbers.

Preferably, the step 2 comprises specific steps of:

2.1: if the log entries contain a corresponding type keyword, obtaining the type keyword of the log entries as the type feature; if the type keyword is not involved, assigning the corresponding type keyword to the log entries according to a process group type to which the log entries belong, and then using the type keyword as the type feature, wherein the type keyword comprises INFO, WARN, and ERROR;

2.2: extracting timestamps of the log entries in the log sequence, and calculating an output time interval between adjacent log entries; using the output time interval as the time feature of the log sequence, wherein a timestamp of a first log entry is directly acquired;

2.3: counting different log entries in the log sequence as the quantity feature of the log sequence; and

2.4: using a One-Hot encoding method for vector encoding of the type feature, the time feature, and the quantity feature, so as to obtain the type feature vector, the time feature vector, and the quantity feature vector; meanwhile, using BERT and TF-IDF to vectorize the semantic feature, wherein BERT converts words of the semantic feature into word vectors, and TF-IDF assigns different weights to the word vectors to obtain vectorized semantic information, which is the semantic feature vector.

Preferably, in the step 3, the attention-mechanism-based BiGRU neural network model comprises a text vectorization input layer, a hidden layer and an output layer in sequence;

wherein the hidden layer comprises a BiGRU layer, an attention layer and a fully connected layer in sequence.

Preferably, the step 4 comprises specific steps of:

inputting the log data set to be detected into the trained BiGRU neural network model for prediction, so as to obtain an occurrence probability of a next log entry in the log sequence; wherein according to the occurrence probability and an actual situation of the log data set, the next log entry of the normal log sequence has a limited number of choices, and a probability ranking threshold K is determined based on a choice range of the next log entry; if the occurrence probability of a certain log entry is within K, the certain log entry is a normal log entry; if all the log entries in the log sequence are normal, the log sequence is the normal log sequence; if the occurrence probability of the certain log entry is out of K, the certain log entry is an abnormal log entry, and the log sequence is the abnormal log sequence.

The present invention also provides a multi-feature log anomaly detection system based on log full semantics, comprising:

a semantic processing module for preliminarily processing a log data set to obtain a log entry word group corresponding to all semantics of a log sequence in the log data set, and using the log entry word group as a semantic feature of the log sequence, wherein the log data set comprises more than one log sequence, and the log sequence is formed by logs generated at intervals or by different processes; the log sequence comprises multiple log entries;

a feature and vector processing module for extracting a type feature, a time feature and a quantity feature of the log sequence, and encoding the semantic feature, the type feature, the time feature and the quantity feature into a log feature vector set of the log sequence, wherein the log feature vector set comprises a type feature vector, a time feature vector, a quantity feature vector and a semantic feature vector;

a training module for training an attention-mechanism-based BiGRU neural network model with all log feature vector sets to obtain a trained BiGRU neural network mode; and

a predicting module for inputting the log data set to be detected into the trained BiGRU neural network model for prediction, and determining whether the log sequence is a normal or abnormal log sequence according to a prediction result.

Preferably, the semantic processing module executes:

1.1: marking the log entries in the log sequence with word segmentation of natural language, in such a manner that each of the log entries obtains a marked word set, wherein words are marked as nouns or verbs;

1.2: splitting the marked word set with a delimiter, wherein the delimiter comprises spaces, colons and commas; and

1.3: converting uppercase letters in a split word set into lowercase letters, and deleting all non-character marks to obtain the log entry word group corresponding to all the semantics of the log sequence, which means the semantic feature of the log sequence is obtained, wherein the non-character marks comprise operators, punctuation, and numbers.

Preferably, the feature and vector processing module executes:

2.1: if the log entries contain a corresponding type keyword, obtaining the type keyword of the log entries as the type feature; if the type keyword is not involved, assigning the corresponding type keyword to the log entries according to a process group type to which the log entries belong, and then using the type keyword as the type feature, wherein the type keyword comprises INFO, WARN, and ERROR;

2.2: extracting timestamps of the log entries in the log sequence, and calculating an output time interval between adjacent log entries; using the output time interval as the time feature of the log sequence, wherein a timestamp of a first log entry is directly acquired;

2.3: counting different log entries in the log sequence as the quantity feature of the log sequence; and

2.4: using a One-Hot encoding method for vector encoding of the type feature, the time feature, and the quantity feature, so as to obtain the type feature vector, the time feature vector, and the quantity feature vector; meanwhile, using BERT and TF-IDF to vectorize the semantic feature, wherein BERT converts words of the semantic feature into word vectors, and TF-IDF assigns different weights to the word vectors to obtain vectorized semantic information, which is the semantic feature vector.

Preferably, in the training module, the attention-mechanism-based BiGRU neural network model comprises a text vectorization input layer, a hidden layer and an output layer in sequence;

wherein the hidden layer comprises a BiGRU layer, an attention layer and a fully connected layer in sequence.

Preferably, the predicting module executes:

inputting the log data set to be detected into the trained BiGRU neural network model for prediction, so as to obtain an occurrence probability of a next log entry in the log sequence; wherein according to the occurrence probability and an actual situation of the log data set, the next log entry of the normal log sequence has a limited number of choices, and a probability ranking threshold K is determined based on a choice range of the next log entry; if the occurrence probability of a certain log entry is within K, the certain log entry is a normal log entry; if all the log entries in the log sequence are normal, the log sequence is the normal log sequence; if the occurrence probability of the certain log entry is out of K, the certain log entry is an abnormal log entry, and the log sequence is the abnormal log sequence.

Compared with the prior art, the present invention has beneficial effects as follows:

1. During log parsing, the full original semantics of the log are extracted instead of using a log parser:

Detection result of the conventional log detection method is affected by the accuracy of log template extraction, the new log template and the OOV word in the log cannot be handled effectively. To overcome such defect, the full semantic text obtained by the present invention will not lose semantic information, and natural language processing is used to automatically encode the full log sequence and extract the semantic features of the log sequences. During extracting semantic features and vectorizing the semantics of the log, BERT and TF-IDF are combined to vectorize the log sequences, wherein BERT converts words of the semantic feature into word vectors, and TF-IDF assigns different weights to the word vectors, so that the obtained log vectors can better describe the semantic information of the logs.

2. Multi-feature-combined model learning:

Different types of log anomalies are generally reflected in different features. For example, a single log sequence feature can only detect the anomaly that affect the log output order, but cannot detect logical anomalies such as component startup and shutdown as well as file opening and closing, or time anomalies such as delayed output of logs. Conventional log anomaly detection methods usually only use one or two features. However, the present invention combines the semantic feature, the time feature, the quantity feature and the type feature to perform model learning on the data set, so as to detect log anomalies through a predictive multi-classification scheme. As a result, the present invention can solve the problem that a single type of feature cannot cover logical anomalies such as component startup and shutdown, or time anomalies such as delayed output of logs.

### BRIEF DESCRIPTION OF THE DRAWINGS

FIG. 1 is an overall framework diagram of the present invention, wherein T1 represents a type feature vector, T2 represents a time feature vector, S represents a semantic feature vector, N represents a quantity feature vector; V1 . . . Vn represent log feature vector sets which are input to a BiGRU model, and H1 . . . Hn represent forward GRU layers and reverse GRU layers of BiGRU; and

FIG. 2 illustrates an attention-mechanism-based BiGRU model, wherein Dense represents a fully connected layer; Word_attention_layer or Attentionion-Based Mask represents a attention layer, namely an attention mechanism; BiGRU represents a BiGRU layer, and Non-Linear Layer or Softmax represents an output layer.

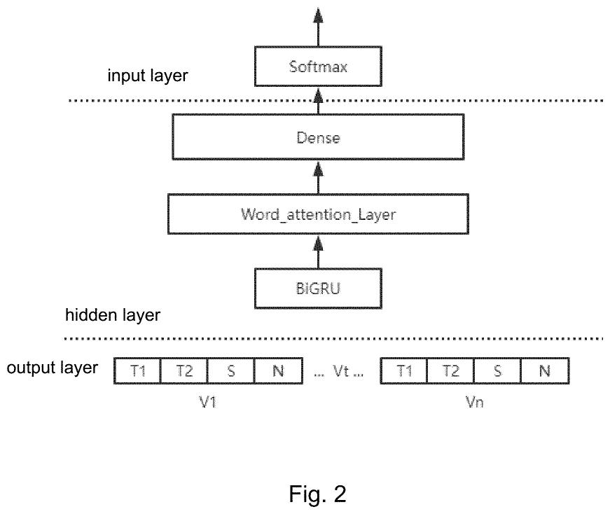

### DETAILED DESCRIPTION OF THE PREFERRED EMBODIMENT

Referring to the accompanying drawings and embodiment, the present invention will be further described.

A single log semantic feature or a small number of features cannot cover all the information of log entries, and a novel multi-feature method is needed to completely extract log feature information.

Specifically:

1. Log Parsing

Preprocessing log data is the first step to establish a model. In this step, log entries are labeled as a group of word marks. Common delimiters are used in a log system (i.e. spaces, colons, commas, etc.) to separate logs. Then uppercase letters are converted to lowercase letters to obtain a word set formed by all words. All non-character marks are removed from the word set. These non-character marks comprise operators, punctuation, and numbers. Such non-characters are removed because they usually represent variables in the logs and are not informative. For example, the word set of a log entry in the original log sequence is: 081109 205931 13 INFO dfs.DataBlockScanner: Verificationsucceeded for blk-4980916519894289629. First the word set is split according to common delimiters, then non-character marks are removed from the split word set. Finally, the word set is {info, dfs, datablockscanner, verification, succeeded}. This word set contains richer log semantic information than the log template does, so it can be used as a semantic text of the log to extract semantic vector.

2. Feature Extraction

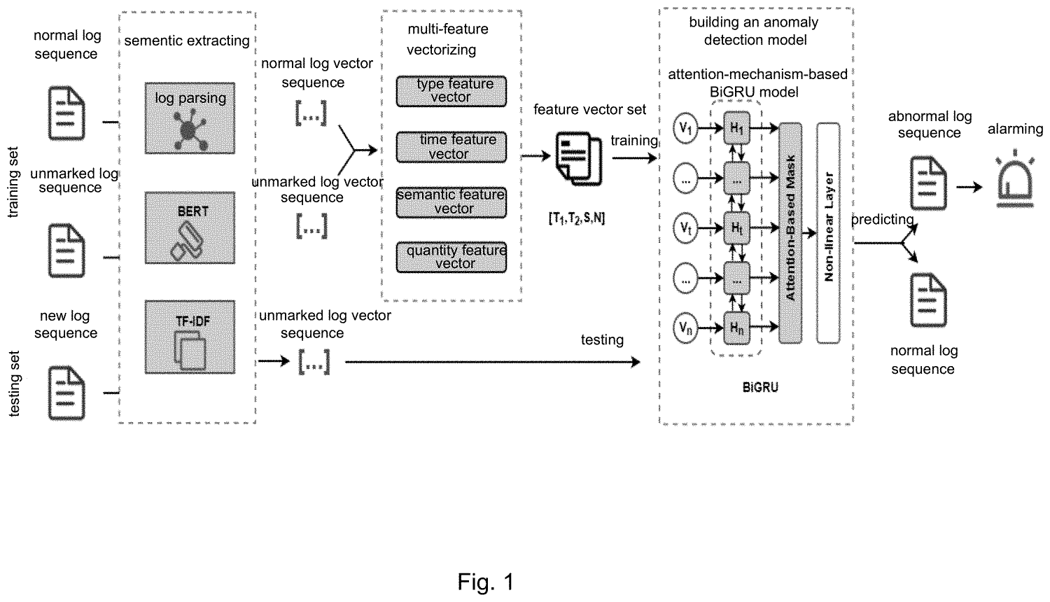

For different system logs, structures thereof are mostly the same. In order to extract as much information as possible from the log sequences, features of log entries in the log sequences are divided into four categories: type features, time features, semantic features and quantity features, corresponding to a multi-feature vector set shown in FIG. 1: [T1,T2,S,N].

A log entry word group obtained in the log sequence parsing is vectorized to obtain the semantic feature vector of the log sequence. Specifically, BERT is used to train word texts in the semantic feature, so that vector expression of the word in the log entry can be obtained. Then, weights are given to the word vectors by TF-IDF, so that the word vectors are weighted and summed to obtain a fixed-dimensional expression of the log semantic information. TF-IDF is a widely used feature extraction method, which is a measure of how important a word is to a document in a corpus. Term Frequency-Inverse Document Frequency (TF-IDF) is a statistical method for evaluating the importance of a word to a document in a document set or corpus. The importance of a word increases proportionally with the number of times it occurs in a document, but it also decreases proportionally with how often it occurs in the corpus.

In the log sequence, the type of the current log entry is usually output, comprising INFO, WARN, and ERROR, so the type keyword of each log entry is obtained as the type feature. If the type keyword is not provided, the corresponding type keyword is assigned to the log entries according to a process group type to which the log entries belong, and then the type keyword is used as the type feature. For example, the corresponding type keyword is assigned according to a certain block in a distributed system to which the log entry belongs or according to a certain process which outputs the log entry.

For the time feature of the log sequence, timestamp of outputting the current log entry can usually be extracted from the log entry. After calculating an output time interval between adjacent log entries, the output time interval is used as the time feature of the log sequence, wherein a timestamp of a first log entry is directly acquired.

The quantity feature represents the quantity of the same log entries in a log sequence, which is obtained by counting different log entries in the log sequence. Therefore, for training the log data set, these four types of features can usually be proposed: the type feature type_vec=[MsgId,ComponentId], the time feature time_vec=[TimeInterval], the quantitaty feature num_vec, and the semantic feature semantic_vec=[msgWords]. MsgId refers to the type INFO of the log entry, ComponentId refers to related component of the log entry, TimeInterval refers to the output time interval from a previous log, and msgWords refers to a word list having the semantics of the log entry. For semantic texts, the word set and sub word set are transmitted to the BERT model, and TF-IDF weights the word vector of each word, thereby encoding it into a vector express with fixed dimension. For the type features, the time features and the quantity features, since there is no special contextual semantic relationship, One-Hot encoding is used to process them.

3. Model Training

BiGRU-Attention model is divided into three parts: a text vectorization input layer, a hidden layer and an output layer, wherein the hidden layer comprises a BiGRU layer, an attention layer and a Dense layer (fully connected layer). A structure of the BiGRU-Attention model is shown in FIG. 1. The input layer preprocesses the vectorized log sequence. Calculation of the hidden layer is mainly divided into two steps:

a) calculating a vector output by the BiGRU layer, wherein a text vector (vectorized texts are input into the input layer) is an input vector of the BiGRU layer; a main purpose of the BiGRU layer is to extract deep text features from the input text vector; according to the BiGRU neural network model diagram, the BiGRU layer can be regarded as composed of two parts: forward GRU and reverse GRU; and

b) calculating a probability weight that should be assigned to the word vector, which is mainly to assign corresponding probability weights to different word vectors, thereby further extracting the text features, and highlighting key information of the text; the step 6) comprises specific steps of:

introducing an attention layer into the BiGRU-Attention model, wherein an input of the attention layer is a hidden layer state of each layer in a previous layer after BiGRU layer activation; the attention layer is a cumulative sum of products of different probability weights assigned by the attention mechanism and the hidden layer states of the BiGRU layer.

An input of the output layer is an output of the previous attention layer. The output layer uses a softmax function to normalize the input.

The attention-mechanism-based BiGRU neural network model is trained based on all log feature vector sets, so as to obtain a trained BiGRU neural network model.

For each log sequence, the above four types of feature vectors are extracted as its feature set Featureᵢ=[Type_Vecᵢ, Time_Vecᵢ, Semantic_Vecᵢ, Num_Vecᵢ], wherein the feature set corresponds to the type feature vector T1, the time feature vector T2, the semantic feature vector S and the quantity feature vector N of the log entry, and then sliding window is used to finish training. To be more detailed, taking a size of window=5 as an example, an input sequence of a certain sliding window is [Feature₁, Feature₂, Feature₂, Feature₄, Feature₅], wherein Featureᵢ refers to the feature vector of an i-th log sequence. Finally, model training is performed in a normal log data set, and training effect is tested on normal and abnormal log data sets.

4. Anomaly Detection

Anomaly detection comprises steps of: inputting the log data set to be detected into the trained BiGRU neural network model for prediction, so as to obtain an occurrence probability of a next log entry in the log sequence; wherein according to the occurrence probability and an actual situation of the log data set, the next log entry of the normal log sequence has a limited number of choices, and a probability ranking threshold K is determined based on a choice range of the next log entry; if the occurrence probability of a certain log entry is within K, the certain log entry is a normal log entry; if all the log entries in the log sequence are normal, the log sequence is the normal log sequence; if the occurrence probability of the certain log entry is out of K, the certain log entry is an abnormal log entry, and the log sequence is the abnormal log sequence.

The above is only a representative embodiment of the present invention, which is chosen from numerous specific applications and not intended to be limiting. All technical solutions formed by transformation or equivalent replacement shall fall within the protection scope of the present invention.

What is claimed is:

1. A multi-feature log anomaly detection method based on log full semantics, comprising steps of:
1: preliminarily processing a log data set to obtain a log entry word group corresponding to all semantics of a log sequence in the log data set, and using the log entry word group as a semantic feature of the log sequence, wherein the log data set comprises more than one log sequence, and the log sequence is formed by logs generated at intervals or by different processes; the log sequence comprises multiple log entries;
2: extracting a type feature, a time feature and a quantity feature of the log sequence, and encoding the semantic feature, the type feature, the time feature and the quantity feature into a log feature vector set of the log sequence, wherein the log feature vector set comprises a type feature vector, a time feature vector, a quantity feature vector and a semantic feature vector;
3: training an attention-mechanism-based BiGRU neural network model with all log feature vector sets to obtain a trained BiGRU neural network mode; and
4: inputting the log data set to be detected into the trained BiGRU neural network model for prediction, and determining whether the log sequence is a normal or abnormal log sequence according to a prediction result.

2. The multi-feature log anomaly detection method, as recited in claim 1, wherein the step 1 comprises specific steps of:
1.1: marking the log entries in the log sequence with word segmentation of natural language, in such a manner that each of the log entries obtains a marked word set, wherein words are marked as nouns or verbs;
1.2: splitting the marked word set with a delimiter, wherein the delimiter comprises spaces, colons and commas; and
1.3: converting uppercase letters in a split word set into lowercase letters, and deleting all non-character marks to obtain the log entry word group corresponding to all the semantics of the log sequence, which means the semantic feature of the log sequence is obtained, wherein the non-character marks comprise operators, punctuation, and numbers.

3. The multi-feature log anomaly detection method, as recited in claim 2, wherein the step 2 comprises specific steps of:
2.1: if the log entries contain a corresponding type keyword, obtaining the type keyword of the log entries as the type feature; if the type keyword is not involved, assigning the corresponding type keyword to the log entries according to a process group type to which the log entries belong, and then using the type keyword as the type feature, wherein the type keyword comprises INFO, WARN, and ERROR;
2.2: extracting timestamps of the log entries in the log sequence, and calculating an output time interval between adjacent log entries; using the output time interval as the time feature of the log sequence, wherein a timestamp of a first log entry is directly acquired;
2.3: counting different log entries in the log sequence as the quantity feature of the log sequence; and
2.4: using a One-Hot encoding method for vector encoding of the type feature, the time feature, and the quantity feature, so as to obtain the type feature vector, the time feature vector, and the quantity feature vector; meanwhile, using BERT and TF-IDF to vectorize the semantic feature, wherein BERT converts words of the semantic feature into word vectors, and TF-IDF assigns different weights to the word vectors to obtain vectorized semantic information, which is the semantic feature vector.

4. The multi-feature log anomaly detection method, as recited in claim 3, wherein in the step 3, the attention-mechanism-based BiGRU neural network model comprises a text vectorization input layer, a hidden layer and an output layer in sequence;
wherein the hidden layer comprises a BiGRU layer, an attention layer and a fully connected layer in sequence.

5. The multi-feature log anomaly detection method, as recited in claim 4, wherein the step 4 comprises specific steps of:
inputting the log data set to be detected into the trained BiGRU neural network model for prediction, so as to obtain an occurrence probability of a next log entry in the log sequence; wherein according to the occurrence probability and an actual situation of the log data set, the next log entry of the normal log sequence has a limited number of choices, and a probability ranking threshold K is determined based on a choice range of the next log entry; if the occurrence probability of a certain log entry is within K, the certain log entry is a normal log entry; if all the log entries in the log sequence are normal, the log sequence is the normal log sequence; if the occurrence probability of the certain log entry is out of K, the certain log entry is an abnormal log entry, and the log sequence is the abnormal log sequence.

6. A multi-feature log anomaly detection system based on log full semantics, comprising:
a semantic processing module for preliminarily processing a log data set to obtain a log entry word group corresponding to all semantics of a log sequence in the log data set, and using the log entry word group as a semantic feature of the log sequence, wherein the log data set comprises more than one log sequence, and the log sequence is formed by logs generated at intervals or by different processes; the log sequence comprises multiple log entries;
a feature and vector processing module for extracting a type feature, a time feature and a quantity feature of the log sequence, and encoding the semantic feature, the type feature, the time feature and the quantity feature into a log feature vector set of the log sequence, wherein the log feature vector set comprises a type feature vector, a time feature vector, a quantity feature vector and a semantic feature vector;
a training module for training an attention-mechanism-based BiGRU neural network model with all log feature vector sets to obtain a trained BiGRU neural network mode; and
a predicting module for inputting the log data set to be detected into the trained BiGRU neural network model for prediction, and determining whether the log sequence is a normal or abnormal log sequence according to a prediction result.

7. The multi-feature log anomaly detection system, as recited in claim 6, wherein the semantic processing module executes:
1.1: marking the log entries in the log sequence with word segmentation of natural language, in such a manner that each of the log entries obtains a marked word set, wherein words are marked as nouns or verbs;
1.2: splitting the marked word set with a delimiter, wherein the delimiter comprises spaces, colons and commas; and
1.3: converting uppercase letters in a split word set into lowercase letters, and deleting all non-character marks to obtain the log entry word group corresponding to all the semantics of the log sequence, which means the semantic feature of the log sequence is obtained, wherein the non-character marks comprise operators, punctuation, and numbers.

8. The multi-feature log anomaly detection system, as recited in claim 7, wherein the feature and vector processing module executes:
2.1: if the log entries contain a corresponding type keyword, obtaining the type keyword of the log entries as the type feature; if the type keyword is not involved, assigning the corresponding type keyword to the log entries according to a process group type to which the log entries belong, and then using the type keyword as the type feature, wherein the type keyword comprises INFO, WARN, and ERROR;
2.2: extracting timestamps of the log entries in the log sequence, and calculating an output time interval between adjacent log entries; using the output time interval as the time feature of the log sequence, wherein a timestamp of a first log entry is directly acquired;
2.3: counting different log entries in the log sequence as the quantity feature of the log sequence; and
2.4: using a One-Hot encoding method for vector encoding of the type feature, the time feature, and the quantity feature, so as to obtain the type feature vector, the time feature vector, and the quantity feature vector; meanwhile, using BERT and TF-IDF to vectorize the semantic feature, wherein BERT converts words of the semantic feature into word vectors, and TF-IDF assigns different weights to the word vectors to obtain vectorized semantic information, which is the semantic feature vector.

9. The multi-feature log anomaly detection system, as recited in claim 8, wherein in the training module, the attention-mechanism-based BiGRU neural network model comprises a text vectorization input layer, a hidden layer and an output layer in sequence;
wherein the hidden layer comprises a BiGRU layer, an attention layer and a fully connected layer in sequence.

10. The multi-feature log anomaly detection system, as recited in claim 9, wherein the predicting module executes:
inputting the log data set to be detected into the trained BiGRU neural network model for prediction, so as to obtain an occurrence probability of a next log entry in the log sequence; wherein according to the occurrence probability and an actual situation of the log data set, the next log entry of the normal log sequence has a limited number of choices, and a probability ranking threshold K is determined based on a choice range of the next log entry; if the occurrence probability of a certain log entry is within K, the certain log entry is a normal log entry; if all the log entries in the log sequence are normal, the log sequence is the normal log sequence; if the occurrence probability of the certain log entry is out of K, the certain log entry is an abnormal log entry, and the log sequence is the abnormal log sequence.
